(19) United States
(12) Patent Application Publication
(10) Pub. No.: US 2012/0139848 A1
(43) Pub. Date: Jun. 7, 2012

(54) Touch screen panel

(76) Inventors: Kyu-Taek Lee, Yongin-City (KR); Mikiya Itakura, Yongin-City (KR)

(21) Appl. No.: 13/067,253

(22) Filed: May 19, 2011

(30) Foreign Application Priority Data
Dec. 6, 2010 (KR) 10-2010-0123440

(51) Int. Cl. G06F 3/041

(52) U.S. Cl. 345/173

(57) ABSTRACT

A touch screen panel includes a glass substrate having reinforcing layers on a first side and a second side, sensing patterns in an active area on the first side of the glass substrate, a black matrix in a non-active area adjacent to the active area, and an overcoat layer covering sides of the black matrix. The touch screen panel includes an insulating layer extending to a cut-side of the glass substrate and covering the overcoat layer, sensing lines partially overlapping the black matrix and connected to the sensing patterns, and the cut-side of the glass substrate having an exposed non-reinforced surface that is a rounded edge.

### CROSS-REFERENCE TO RELATED APPLICATION

This application claims priority to and the benefit of Korean Patent Application No. 10-2010-0123440, filed on Dec. 6, 2010, in the Korean Intellectual Property Office, the entire content of which is incorporated herein by reference.

### BACKGROUND

1. Field

Embodiments relates to a touch screen panel that is provided in an image display device, etc.

2. Description of the Related Art

Touch screen panels may be used as input devices that, e.g., select contents displayed on the screen of an image display device, etc. Touch screen panels may incorporate the use of a person's hand or an object to input commands of a user.

Touch screen panels may be provided on a front face of the image display device and may convert positions where a person's hand or an object contacts, e.g., directly contacts, into electrical signals. Recently, the trend has been to develop a thin touch screen panel because, as the entire volume of the touch screen panel increases, portability may be reduced.

### SUMMARY

Embodiments are directed to a touch screen panel having improved yield strength and productivity.

Embodiments are also directed to a touch screen panel of which the outermost cross-sectional structure protects a black matrix from being damaged.

Embodiments may be realized by providing a touch screen panel that includes a glass substrate having reinforcing layers on a first side and a second side, sensing patterns in an active area on the first side of the glass substrate, a black matrix in a non-active area around the active area, an overcoat layer patterned to cover the sides of the black matrix, an insulating layer extending to a cut-side of the glass substrate and covering the overcoat layer, and sensing lines partially overlapping the black matrix and connected with the sensing patterns, in which the edge of a non-reinforced surface exposed at the cut-side of the glass substrate is rounded.

In this configuration, the insulating layer may be made of oxidized aluminum Al₂O₃ or oxidized tantalum Ta₂O₅.

Further, a transparent conductive pattern may be further formed on the insulating layer in the non-active area, and the transparent conductive pattern may surround the edge of the non-active area of the touch screen panel and may have at least one or more stacked structures.

Further, the transparent conductive pattern may be made of the same material as the sensing pattern in the active area and by the same process.

Further, the glass substrate with the reinforcing layers may function as a window, the second surface may be the surface that is exposed to the outside in contact, and the reinforcing layer may be implemented when natrium, i.e., sodium (Na), on the surface of the glass substrate is substituted into kalium, i.e., potassium (K).

Further, the edge may be rounded by chemical solution contacting to a non-reinforced surface exposed at the cut-side of the glass substrate and the chemical solution may be a HF-based solution containing an inorganic acid and an ammonium-based additive.

According to the embodiments described above, it may be possible to minimize the entire thickness of the touch screen panel by forming sensing electrodes on a window.

Further, it is possible to remove fine cracks on a cut cross-section and ensure yield strength and productivity of a touch screen panel, by reinforcing a glass substrate that is used as a window in a mother substrate and healing a non-reinforcing surface generated by cutting unit cells after forming the touch screen panel for each unit cell region, that is, healing the cut cross-section.

Further, it is possible to minimize, reduce, and/or prevent the matrix adjacent to the cross-section from being damaged in the healing process by changing the structure of the cut outermost cross-section.

### BRIEF DESCRIPTION OF THE DRAWINGS

Features will become apparent to those of ordinary skill in the art by describing in detail exemplary embodiments with reference to the attached drawings in which:

FIG. 1 is a plan view schematically illustrating a touch screen panel according to an exemplary embodiment.

FIG. 2 is an enlarged view showing the main parts of an example of the sensing pattern illustrated in FIG. 1.

FIG. 3 is a cross-sectional view of a touch screen panel according to an exemplary embodiment taken along a portion (I-I′) of the sensing pattern illustrated in FIG. 2.

FIGS. 4A and 4B are cross-sectional views of touch screen panels according to exemplary embodiments taken along a portion (I-I′) of the sensing pattern illustrated in FIG. 2.

FIGS. 5A to 5D are cross-sectional views sequentially illustrating a method of fabricating a touch screen panel according to an exemplary embodiment.

### DETAILED DESCRIPTION

Korean Patent Application No. 10-2010-0123440, filed on Dec. 6, 2010, in the Korean Intellectual Property Office, and entitled: “Touch Screen Panel” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or element, it can be directly on the other layer or element, or intervening layers or elements may also be present.

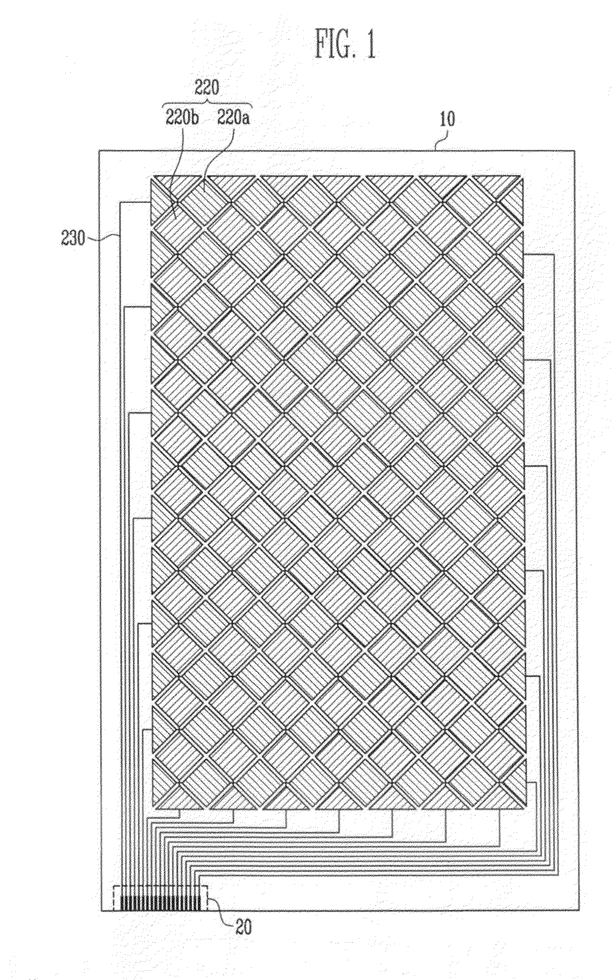

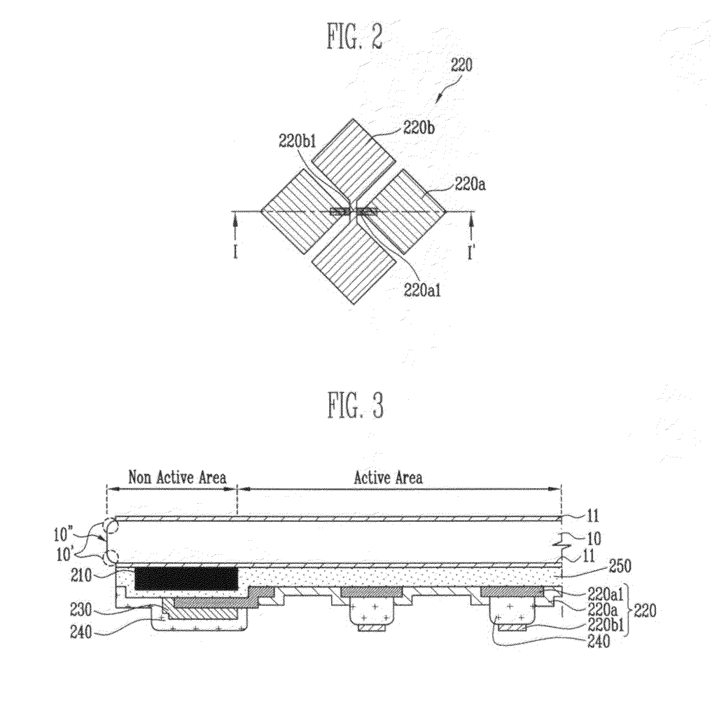

FIG. 1 is a plan view schematically illustrating a touch screen panel according to an exemplary embodiment. Further, FIG. 2 is an enlarged view showing the main parts of an example of the sensing pattern shown in FIG. 1.

Embodiments include a touch screen panel with sensing patterns on a glass substrate, and the figures show a touch screen panel formed by reinforcing the glass substrate in a mother substrate. A plurality of touch screen panels may be formed on the transparent substrate, and may be cut into individual unit cells.

Referring to FIGS. 1 and 2, a touch screen panel according to an exemplary embodiment may include a transparent substrate 10, a sensing pattern 220 on the transparent substrate 10, and sensing lines 230 connecting the sensing pattern 220 with, e.g., an external driving circuit through a pad unit 20.

The sensing pattern 220, as shown in FIG. 2, may include a plurality of first sensing cells 220a formed in connection with each other in a first direction, e.g., in the row direction, in each row. First connecting lines 220a1 may connect the first sensing cells 220a in the row direction. The sensing pattern 220 may include second sensing cells 220b formed in connection with each other in a second direction, e.g., in the column direction, in each column. Second connecting lines 220b1 may connect the second sensing cells 220b in the column direction. The first direction may intersect, e.g., be perpendicular to, the second direction.

Although only some of the sensing patterns are shown in FIG. 2 for the convenience, the touch screen panel has a structure in which the sensing patterns shown in FIG. 2 are repeatedly arranged.

The first sensing cells 220a and the second sensing cells 220b may be alternately arranged not to overlap each other. The first connecting lines 220a1 and the second connecting lines 220b1 may be arranged to intersect each other. Insulating layers (not shown) may be disposed between the first connecting lines 220a1 and the second connecting lines 220b1 to, e.g., ensure stability.

The first sensing cells 220a and the second sensing cells 220b may be made of a transparent materials, such as indium-tin-oxide (hereafter, ITO). The first sensing cells 220a and the second sensing cells 220b may be integrally formed with the first sensing lines 220a1 and the second sensing lines 220b1, respectively, or may be separately formed in electrical connection with each other.

For example, the second sensing cells 220b and the second connecting lines 220b1 may be integrally formed in the column direction. The first sensing cells 220a may be patterned to have independent patterns between the second sensing cells 220b and may be connected in the row direction by the upper or lower first connecting lines 220a1.

In this configuration, the first connecting lines 220a1 may be electrically connected, e.g., in direct contact with, the first sensing cells 220a, above or under the first sensing cells 220a, or may be electrically connected with the first sensing cells 220a through contact holes.

The first connecting lines 220a1 may be made of, e.g., a transparent electrode material, such as ITO, or an opaque low-resistant material, and the width etc. can be adjusted to minimize and/or prevent visualization of patterns, e.g., patterns of first connecting lines 220a1.

The sensing lines 230 may be electrically connected with the first and second sensing cells 220a and 220b in each row and each column and may connect the sensing cells with an external driving circuit (not shown), such as a position detecting circuit, through the pad unit 20.

The sensing lines 230 may be disposed in a non active area around an active area where an image is displayed. The sensing lines 230 may be made of, e.g., a row-resistant material, such as Mo, Ag, Ti, Cu, Al, and Mo/Al/Mo, other than the transparent electrode material used for forming the sensing pattern 220, for the various selectable materials.

The touch panel according to an exemplary embodiment described above is a capacitive type touch panel, in which a contact object, such as human's hand or a stylus pen contacts the touch screen panel, may be used to impart a change of electrostatic capacitance corresponding to the contact position that may be transmitted to the driving circuit (not shown) from the sensing pattern 220 through the sensing lines 230 and the pad unit 20. Accordingly, the change in electrostatic capacitance may be converted into an electric signal by, e.g., an X- and Y-input process circuit (not shown), such that the contact is located.

Though not shown in FIG. 1, a black matrix may be formed on the transparent substrate 10. The black matrix may overlap the sensing lines 230 in the non-active area. The black matrix may reduce, minimize, and/or prevent the patterns, such as the sensing lines 230, from being visualized, and may form a black edge on the screen.

The sensing patterns 220 and the black matrix may be on the same transparent substrate 10 and an overcoat layer is on the black matrix to, e.g., reduce a step due to the black matrix.

The touch screen panel may be formed on an individual substrate and attached on an image display device, etc. However, this case has a defect that the entire thickness of the display device may be increased.

Accordingly, an exemplary embodiment characterized in that the upper side of the transparent substrate 10 is a surface that a contact object directly contacts with, e.g., the transparent substrate 10 functions as a window of a display device.

That is, the window is integrated with the transparent substrate of the touch screen panel, without providing an individual window. Therefore, it is possible to improve manufacturing efficiency by simplifying the manufacturing process and reducing the material cost, in addition to implementing a thin touch screen panel.

For this configuration, the transparent substrate 10 may be formed of a reinforced glass substrate to function as a window, such that an exemplary embodiment has a large advantage in enhancing and/or ensuring productivity by not applying reinforcement for unit cells, but applying reinforcement for the raw sheet substrate before cutting it in unit cells.

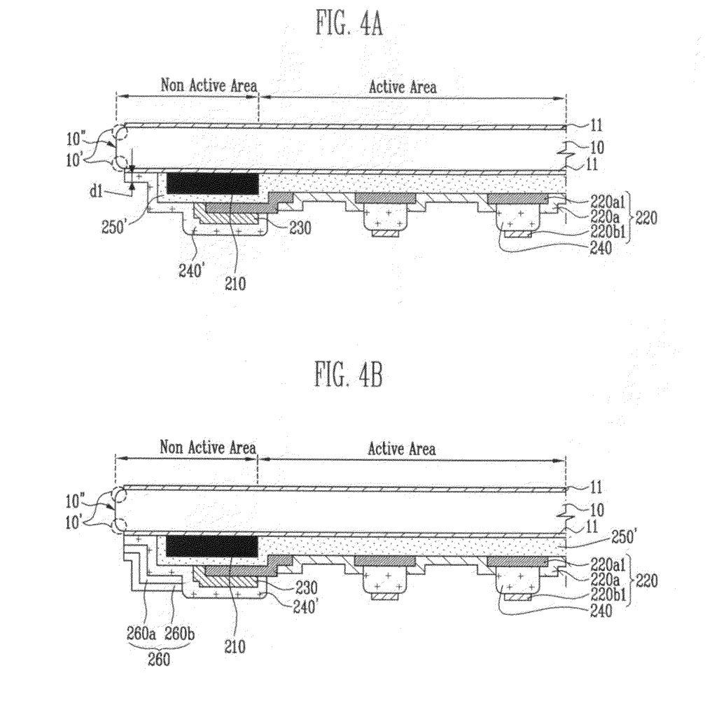

FIG. 3 is a cross-sectional view of a portion (I-I′) of a touch screen panel according to an exemplary embodiment.

FIG. 3 is a view showing a cross-section showing one side of a touch screen panel on a reinforced glass substrate which has been cut in unit cells.

In this configuration, e.g., the reinforced glass substrate may be formed by immersing the glass substrate into KNO₃ solution and heating it at about 400° C. to about 450° C. for about 15 to about 18 hours, such that natrium, i.e., sodium (Na), on the surface of the glass substrate is substituted to kalium, i.e., potassium (K), by the process, thereby improving surface strength of the glass substrate.

Without intending to be bound by this theory, as shown in FIG. 3, a reinforcing layer 11 formed on the surface of the reinforced glass substrate 10 may have improved strength by substitution of sodium (Na) on the surface into potassium (K).

Further, the sensing patterns 220 in the active region of the reinforced glass substrate 10 may include the first sensing cells 220 connected in a first direction in each row, the first connecting lines 220a1 connecting the first sensing cells 220a in the row direction, the second sensing cells 220b connected in the column direction in each column, and the second connecting lines 220b1 connecting the second sensing cells 220b in the column direction, in which insulating layers 240 are disposed at the intersections of the first connecting lines 220a1 and the second connecting lines 220b1.

The insulating layer 240 may be made of at least one of silicon oxide SiO₂ and silicon nitride SiNₓ.

Further, black matrixes 210 and sensing lines 230 may overlap each other, e.g., the black matrixes may overlap in the sensing lines 230. At least the sensing lines 230 may be electrically connected with the sensing patterns 220 in the non-active area around the active area, as shown in the FIG. 3.

The black matrixes 210 may minimize, reduce, and/or prevent the patterns, such as the sensing lines, from being visualized and may form the edge of the display region.

Further, the overcoat layer 250 may be on the black matrix 210 to reduce the step due to the black matrix 210.

In this configuration, the overcoat layer 250 may be formed on the front side of a substrate including the black matrix 210. The overcoat layer 250 may be made of poly-imide, acryl, or an inorganic insulating layer SiNₓ.

The black matrix 210, the overcoat layer 250, the sensing patterns 220, the sensing lines 230, and the insulating layer 240, which are shown in FIG. 3, are enlarged in thickness and area for the convenience of description. According to an exemplary embodiment, they are very thinner than the glass substrate 10.

When the reinforced raw sheet substrate is cut in unit cells, the cut cross-section, that is, a non-reinforced side of the exposed glass substrate may remain after cutting. In an exemplary embodiment, it is possible to ensure productivity and improve yield strength of the touch screen panel by removing fine cranks on the cut side, by healing the exposed cut side.

The healing is a process that, e.g., contacts chemical solution to a cut surface 10″ of the glass substrate 10. The chemical solution may be HF-based solution.

For example, the chemical solution may contain HF, inorganic acid, and an ammonium-based additive.

The chemical solution containing HF may contact with the exposed cut side, i.e., the cut surface 10″, in the healing process, such that the sharp inner portions of the fine crack generated on the cut surface 10″ is depressed smooth and/or the outer region of the cut cross-section with the fine crack can be removed.

Further, after the process for the cut surface 10″ is finished, the edge 10′ of the cut surface may be rounded, as shown in the cross-sectional view of FIG. 3.

However, in the embodiment shown in FIG. 3, the black matrix 210 adjacent to the cut cross-section may be damaged in the healing process.

That is, as shown in FIG. 3, the overcoat layer 250 and the insulating layer 240 may be exposed on the cut cross-section, in which the chemical solution used for the healing process may permeated the overcoat layer 250 and the insulating layer 240, such that it may damage the black matrix 210.

Without intending to be bound by this theory, the permeating chemical solution may cause the black matrix 210 to come undone and/or make the external appearance bad by reducing adhesion of the black matrix 210 and the overcoat layer 250 thereon.

Therefore, another exemplary embodiment is characterized by minimizing, reducing, and/or preventing the black matrix adjacent to the cross-section from being damaged in the healing process by changing the structure of the cut outermost cross-section.

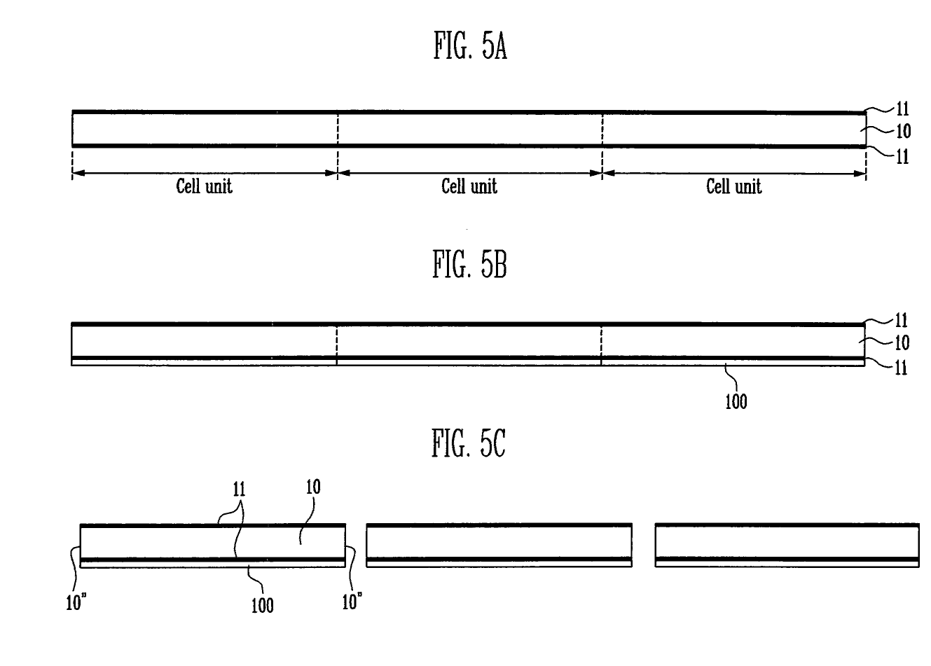

FIGS. 4A and 4B are cross-sectional views of a portion (I-I′) of a touch screen panel according to another exemplary embodiment.

The cross-sectional views in FIGS. 4A and 4B are the similar to the cross-sectional view for the same region in the embodiment shown in FIG. 3, that is, cross-sectional view of a portion formed by cutting a touch screen panel on a reinforced glass substrate in a unit cell, such that the same components are given the same reference numerals.

Referring FIG. 4A, the black matrix 210, an overcoat layer 250′, sensing lines 230, and an insulating layer 240′ may be in a non-active area including a cut cross-section.

The structure of the active area may be the same as that in the embodiment shown in FIG. 3 and the detailed description is not provided.

Referring to FIG. 4A, the overcoat layer 250′ may not extend to an area under the cut-side 10″ of the substrate. The overcoat layer 250′ may be patterned to cover the sides of the black matrix 210, such that sides of the overcoat layer 250′ fully cover the insulating layer 240′.

Therefore, the overcoat layer 250′ may not be exposed at the cut-side, and as shown in FIG. 4A, only the insulating layer 240′ fully covering the overcoat layer 250′ and extending to the cut-side of the substrate may be exposed by a thickness d1. In this structure, the thickness, e.g., thickness d1, of the insulating layer 240′ may be about 500 Å.

The insulating layer 240′ may be characterized by being made of, not silicon oxide SiO₂ or silicon nitride SiNₓ, which is general inorganic substances in the embodiment shown in FIG. 3, but oxidized aluminum Al₂O₃ and oxidized tantalum Ta₂O₅ in order to, e.g., increase fluoric acid resistance in the embodiment shown in FIG. 3.

The insulating layer 240 in the active area may be made of the same material as the insulating layer 240′ in the non-active area by the same process, but it is not limited thereto. For example, the insulating layer in the active area may be made of existing inorganic substances.

By using this structure, the chemical solution containing fluoric acid HF used for the healing process when performing the healing process after cutting may be blocked by the insulating layer 240′ having fluoric acid resistance, such that is it possible to minimize, reduce, and/or prevent the black matrix 210 from being damaged.

The embodiment shown in FIG. 4B may be characterized by further including a transparent conductive pattern 260 on the insulating layer 240′ in the non-active area, in addition to the configuration of the embodiment shown in FIG. 4A.

The transparent conductive pattern 260 may surround the edge of the non-active area of the touch screen, where voltage is not individually applied and which is provided to, e.g., minimize, reduce, and/or prevent the chemical solution used for the healing process from permeating the touch screen panel.

The transparent conductive pattern 260 may be implemented by at least one layer 260a and 260b. The transparent conductive pattern 260 may be made of the same material as the sensing pattern in the active area by the same process, but it not limited thereto.

By using this structure, the chemical solution containing fluoric acid HF used for the healing process when performing the healing process after cutting may be blocked by the insulating layer 240′ having fluoric acid resistance and the transparent conductive pattern 260, such that is it possible to minimize, reduce, and/or prevent the black matrix 210 from being damaged.

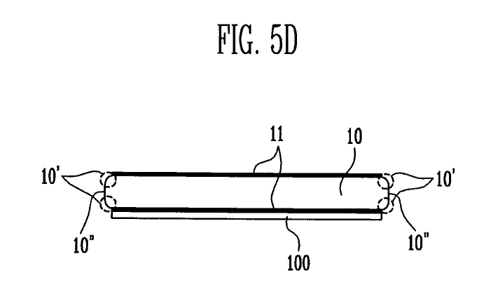

A process of fabricating a touch screen panel according to an exemplary embodiment is described with reference to FIGS. 5A to 5D.

FIGS. 5A to 5D are cross-sectional views sequentially illustrating a method of fabricating a touch screen panel according to an exemplary embodiment.

First, referring to FIG. 5A, reinforcement may be applied for a mother substrate 10, that is, for the entire surface of the glass substrate where a plurality of touch screen panels is formed in unit cells.

The reinforcement may be performed by immersing the glass substrate 10 into KNO₃ solution and heating it at about 400° C. to about 450° C. for about 15 to about 18 hours, such that natrium, i.e., sodium (Na), on the surface of the glass substrate may be substituted to kalium, i.e., potassium (K), by the process, thereby improving surface strength of the glass substrate. That is, a reinforcing layer 11 may be formed on the surface of the glass substrate after the reinforcing. However, it is just an embodiment and the reinforcing of the glass substrate it not limited thereto.

Next, as shown in FIG. 5B, the touch screen panels 100 may be formed for each unit cell region of the mother substrate.

Referring to FIG. 5B, an embodiment exemplifies when the mother substrate 10 is composed of three unit cells for the convenience of description and the embodiments are not limited thereto.

Further, as described above with reference to FIGS. 1 to 3, the touch screen panel 100 may include the sensing patterns 220 in the active area, the black matrixes 210 in the non-active area, the overcoat layer 250, and the sensing lines 230, and the detailed description for the components is not provided for the convenience of description in FIG. 5B.

Next, referring to FIG. 5C, the unit cell regions may be cut, after the touch screen panels 100 are completely formed for each unit cell region. The cutting may be implemented physically or chemically by, e.g., a wheel, a laser, water-jet, and etching. After the cutting has been finished, a step of polishing the cut side may be further included.

However, a non-reinforced surface 10″ may be exposed on the cut side after the cutting and fine cracks exist, such that the fine cracks may be a cause reducing reliability of a product.

Therefore, according to an exemplary embodiment, reliability of a product may be enhanced and/or ensured by healing the non-reinforced surface, that is, the exposed cut side 10″.

The healing is a process that may contact chemical solution to the cut surface 10″, in which the chemical solution may be HF-based solution.

For example, the chemical solution may contain HF, inorganic acid, and an ammonium-based additive.

The chemical solution containing HF contacts with the exposed cut side 10″ in the healing process, such that the sharp inner portions of the fine crack generated on the cut surface 10″ may be depressed smooth and/or the outer region of the cut cross-section with the fine crack may be removed.

Thereafter, after the healing is finished, the touch screen panel 100 on the reinforced glass substrate 10 having the cut-side 10″ with the smooth edge 10′ may be completed, as shown in FIG. 5D.

By way of summation and review, as the touch screen panels can replace separate input devices that are operated by being connected with the image display device such as a keyboard and a mouse, the use field of the touch screen panels is being expanded gradually.

It is necessary to develop a thin touch screen panel because the entire volume increases and portability may be reduced, when a touch screen panel is attached on the panel of an image display device. However, a window may be additionally disposed on common touch screen panels to increase mechanical strength, which also increases the thickness of the touch screen panel and runs counter to the tendency that the touch screen panels are decreased in thickness.

Further, although it is general to implement the window, using a reinforced glass substrate, it is required to cut an organic substrate in cells and individually reinforcing them in order to use a reinforced glass substrate for the window. However, it may be difficult to ensure productivity when fabricating a touch screen panel, using the unit cell windows.

Further, fabricating a touch screen panel in a raw sheet, using a non-reinforced glass substrate, decreases the yield strength of the window, such that it cannot function as the window.

A touch screen panel may have improved yield strength and productivity by reinforcing a glass substrate, which is used for a window in a raw sheet, and healing the non-reinforced side that is generated by cutting each cell region after forming a touch screen panel for each cell region, that is, healing the cut cross-sections, in implementing a window-integrated touch screen panel with sensing electrodes on the window.

Embodiments are also directed to a touch screen panel of which the outermost cross-sectional structure is changed to minimize, reduce, and/or prevent a black matrix adjacent to the cross-section from being damaged in the healing process.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof. Accordingly, it will be understood by those of ordinary skill in the art that various changes in form and details may be made without departing from the spirit and scope of the present invention as set forth in the following claims.

What is claimed is:

1. A touch screen panel, comprising:
a glass substrate having reinforcing layers on a first surface and a second surface;
sensing patterns in an active area on the first surface of the glass substrate;
a black matrix in a non-active area adjacent to the active area;
an overcoat layer covering sides of the black matrix;
an insulating layer extending to a cut-side of the glass substrate and covering the overcoat layer;
sensing lines partially overlapping the black matrix and connected to the sensing patterns; and
the cut-side of the glass substrate having an exposed non-reinforced surface that is a rounded edge.

2. The touch screen panel according to claim 1, wherein the insulating layer includes at least one of oxidized aluminum Al₂O₃ or oxidized tantalum Ta₂O₅.

3. The touch screen panel according to claim 1, further comprising a transparent conductive pattern on the insulating layer in the non-active area.

4. The touch screen panel according to claim 3, wherein the transparent conductive pattern surrounds an edge of the non-active area of the touch screen panel.

5. The touch screen panel according to claim 3, wherein the transparent conductive pattern has a stacked structure including a plurality of layers.

6. The touch screen panel according to claim 3, wherein the transparent conductive pattern is made of the same material as the sensing pattern in the active area and by the same process.

7. The touch screen panel according to claim 1, wherein the glass substrate with the reinforcing layers is a window of the touch screen panel and the second surface is exposed to an outside environment for contact.

8. The touch screen panel according to claim 1, wherein at least one of the reinforcing layers is implemented when natrium (Na) on the surface of the glass substrate is substituted by kalium (K).

9. The touch screen panel according to claim 1, wherein the exposed non-reinforced surface is rounded by a chemical solution contacting the exposed non-reinforced surface at the cut-side of the glass substrate.

10. The touch screen panel according to claim 9, wherein the chemical solution is a HF-based solution including an inorganic acid and an ammonium-based additive.
